(19) United States
(12) Patent Application Publication
(10) Pub. No.: US 2026/0215561 A1
(43) Pub. Date: Jul. 30, 2026

(54) MAGNETIC MARKER DEVICE

(71) Applicants: Meghan Junor, Statesboro, GA (US); Patrick Junor, Statesboro, GA (US)

(72) Inventors: Meghan Junor, Statesboro, GA (US); Patrick Junor, Statesboro, GA (US)

(21) Appl. No.: 19/041,551

(22) Filed: Jan. 30, 2025

(51) Int. Cl. A45C 11/32; B43K 8/02; B43K 23/08; B43K 29/00

(52) U.S. Cl. CPC A45C 11/32; B43K 8/02; B43K 23/08; B43K 29/00

(57) ABSTRACT

A magnetic marker device includes a plurality of markers and a plurality of caps each removably matable to a respective marker of the plurality of markers. A plurality of first annular magnets is each coupled to a respective one of the plurality of markers. A plurality of second annular magnets is each coupled to a respective one of the plurality of caps. The second annular magnet on the respective cap magnetically engages a respective first annular magnet on a respective marker for retaining the respective cap on the respective marker. A plurality of third annular magnets is each coupled to a respective cap. A plurality of fourth annular magnets is each coupled to a respective marker. The third annular magnet on a respective cap magnetically engages the fourth annular magnet on a respective marker to store the respective cap when the respective marker is employed for writing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to marker devices and more particularly pertains to a new marker device for magnetically storing a cap on a marker. The device includes a plurality of markers and a plurality of caps that is each releasably matable to a respective marker. The device includes a plurality of first annular magnets that is each attached to a respective marker and a plurality of second annular magnets that is each attached to a respective cap. The second annular magnet on a respective cap magnetically engages the first annular magnet of a respective marker to retain the respective cap on the respective marker. The device includes a plurality of third annular magnets each coupled to an opposite end of a respective cap from the second annular magnet on the respective cap. The device includes a plurality of fourth annular magnets each coupled to an opposite end of a respective marker from the first annular magnet on the respective cap. The third annular magnet on a respective cap magnetically engages the fourth annular magnet on a respective marker to store the respective cap when the respective marker is employed for writing.

### (2) Description of Related Art Including Information Disclosed Under 37 Cfr 1.97 and 1.98.

The prior art relates to marker devices including a variety of writing utensils that each at least includes a pen and a cap that is removably matable to the pen and a first magnet coupled to the pen and a second magnet coupled to the cap for magnetically retaining the cap on the pen. In several instances the prior art discloses a lanyard that is attached to the cap which can be worn around a neck of a user. In no instance does the prior art disclose a magnetic marker device that includes plurality of markers and a plurality of caps and a plurality of first annular magnets attached to a respective marker and a plurality of second annular magnets attached to a respective cap for magnetically retaining the respective cap on a respective magnet and a plurality of third annular magnets attached to an opposite end of a respective cap from a respective second annular magnet and a plurality of fourth annular magnets each attached to a respective marker for magnetically retaining a respective cap on a respective marker for storage while the respective marker is being employed for writing.

### (h) Brief Summary of the Invention

An embodiment of the disclosure meets the needs presented above by generally comprising a plurality of markers and a plurality of caps each removably matable to a respective marker of the plurality of markers. A plurality of first annular magnets is each coupled to a respective one of the plurality of markers. A plurality of second annular magnets is each coupled to a respective one of the plurality of caps. The second annular magnet on the respective cap magnetically engages a respective first annular magnet on a respective marker for retaining the respective cap on the respective marker. A plurality of third annular magnets is each coupled to a respective cap. A plurality of fourth annular magnets is each coupled to a respective marker. The third annular magnet on a respective cap magnetically engages the fourth annular magnet on a respective marker to store the respective cap.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a magnetic marker device according to an embodiment of the disclosure.

FIG. 2 is a top exploded perspective view of a marker and a cap of an embodiment of the disclosure.

FIG. 3 is a bottom exploded perspective view of a marker and a cap of an embodiment of the disclosure.

FIG. 4 is a front view of an embodiment of the disclosure showing a cap covering a tip of a marker.

FIG. 5 is a front view of an embodiment of the disclosure showing a cap being stored on a marker.

### (J) DETAILED DESCRIPTION OF THE INVENTION

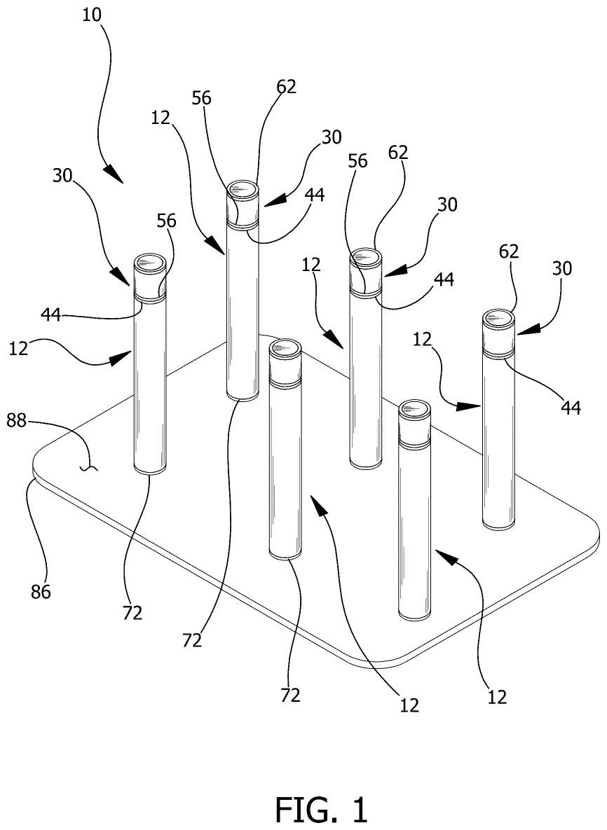

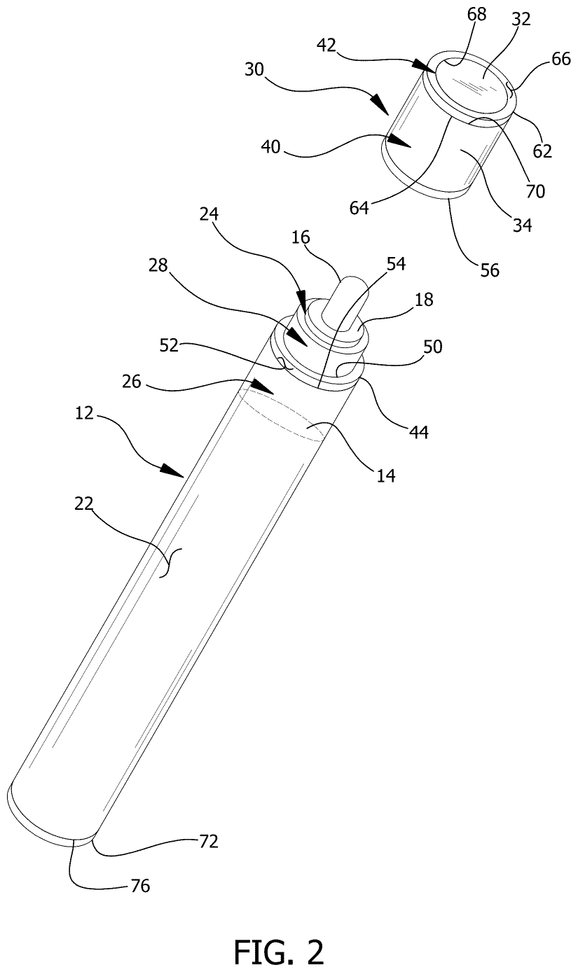

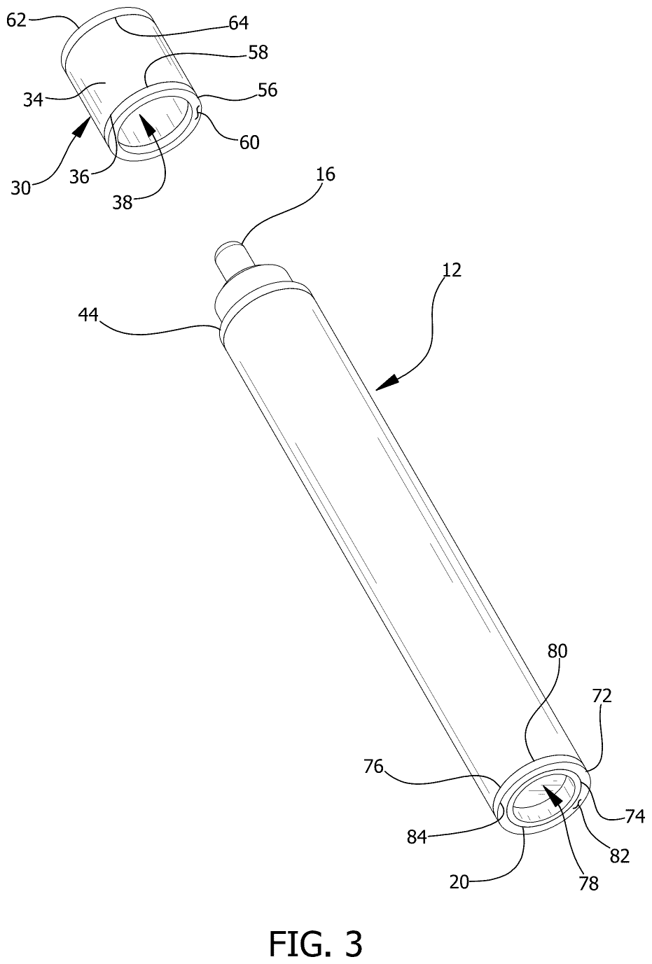

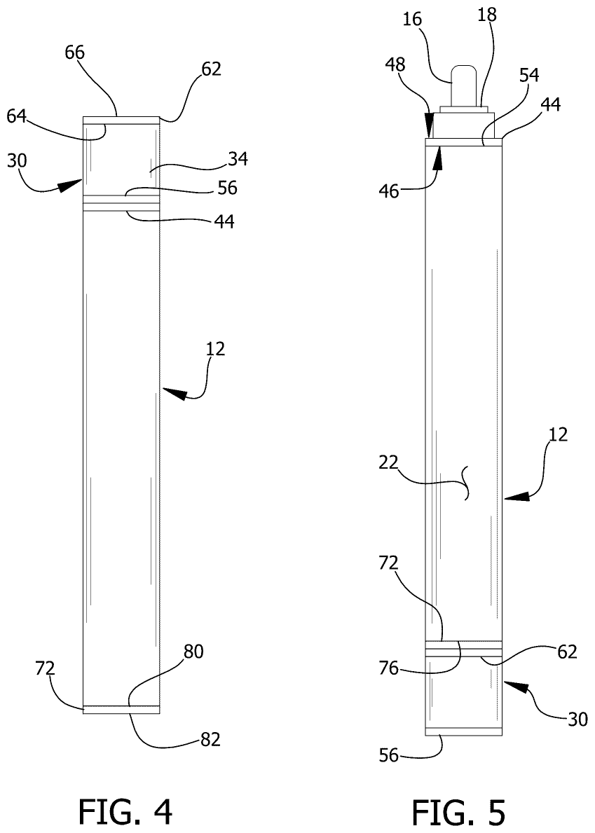

With reference now to the drawings, and in particular to FIGS. 1 through 5 thereof, a new marker device embodying the principles and concepts of an embodiment of the disclosure and generally designated by the reference numeral 10 will be described.

As best illustrated in FIGS. 1 through 5, the magnetic marker device 10 generally comprises a plurality of markers 12 which each stores a fluid ink 14. Each marker 12 of the plurality of markers 12 includes a tip 16 and the tip 16 associated with a respective marker 12 of the plurality of markers 12 is in fluid communication with the fluid ink 14 stored in the respective marker 12. Furthermore, the tip 16 associated with each marker 12 of the plurality of markers 12 is comprised of a fluid permeable material, including but not being limited to felt or polyester or ceramic. The tip 16 associated with a respective marker 12 of the plurality of markers 12 absorbs the fluid ink 14 stored in the respective marker 12. Subsequently, the tip 16 associated with the respective marker 12 can release the fluid ink 14 stored in the respective marker 12 onto a writing surface.

Each marker 12 of the plurality of markers 12 has a top end 18 and a bottom end 20 and an outer surface 22 extending between the top end 18 and the bottom end 20. The outer surface 22 of each marker 12 of the plurality of markers 12 has a first portion 24 and a second portion 26 and a medial portion 28 extending between first portion 24 and the second portion 26. The medial portion 28 of the outer surface 22 of a respective marker 12 of the plurality of markers 12 has a diameter that is less than a diameter of the second portion 26 of the outer surface 22 of the respective marker 12. Additionally, the first portion 24 of the outer surface 22 of the respective marker 12 has a diameter that is less than the diameter of the medial portion 28 of the outer surface 22 of the respective marker 12. The first portion 24 of the outer surface 22 of the respective marker 12 is associated with the top end 18 of the respective marker 12. The second portion 26 of the outer surface 22 of the respective marker 12 is associated with the bottom end 20 of the respective marker 12. Continuing, the medial portion 28 of the outer surface 22 of the respective marker 12 is positioned closer to the top end 18 of the respective marker 12 than the bottom end 20 of the respective marker 12.

A plurality of caps 30 is provided and each cap 30 of the plurality of caps 30 is removably matable to a respective marker 12 of the plurality of markers 12. A respective cap 30 of the plurality of caps 30 covers the tip 16 associated with a respective marker 12 when the respective cap 30 is removably mated to the respective marker 12. Furthermore, the respective cap 30 inhibits the tip 16 associated with the respective marker 12 from drying. Each cap 30 of the plurality of caps 30 has a top wall 32 and an outer wall 34 extending downwardly from the top wall 32. The outer wall 34 of a respective cap 30 of the plurality of caps 30 is continuously arcuate about a center of the top wall 32 of the respective cap 30 such that the respective cap 30 has a cylindrical shape. The outer wall 34 of each cap 30 of the plurality of caps 30 has a lower edge 36 and the lower edge 36 of the outer wall 34 of the respective cap 30 defines an opening 38 into the respective cap 30. Furthermore, the opening 38 in the respective cap 30 insertably receives the tip 16 associated with a respective marker 12 when the respective cap 30 is releasably mated to the respective marker 12.

The outer wall 34 of each cap 30 of the plurality of caps 30 has a primary portion 40 and a secondary portion 42. The secondary portion 42 of the outer wall 34 of a respective cap 30 has a diameter that is less than the primary portion 40 of the outer wall 34 of the respective cap 30. The primary portion 40 of the outer wall 34 of the respective cap 30 is associated with the lower edge 36 of the outer wall 34 of the respective cap 30. Additionally, the secondary portion 42 of the outer wall 34 of the respective cap 30 is associated with the top wall 32 of the respective cap 30.

A plurality of first annular magnets 44 is provided and each first annular magnet 44 of the plurality of first annular magnets 44 is coupled to a respective one of the plurality of markers 12. Each first annular magnet 44 of the plurality of first annular magnets 44 has a lower surface 46 and an upper surface 48. Each first annular magnet 44 of the plurality of first annular magnets 44 has an inwardly facing surface 50 extending between the upper surface 48 and the lower surface 46. Additionally, each first annular magnet 44 of the plurality of first annular magnets 44 has an outwardly facing surface 52 extending between the upper surface 48 and the lower surface 46.

The outer surface 22 of a respective marker 12 of the plurality of markers 12 has a first threshold 54 extending between the medial portion 28 of the outer surface 22 of the respective marker 12 and the second portion 26 of the outer surface 22 of the respective marker 12. The lower surface 46 of each first annular magnet 44 of the plurality of first annular magnets 44 is coupled to the first threshold 54 of a respective marker 12. Additionally, the inwardly facing surface 50 of a respective first annular magnet 44 of the plurality of first annular magnets 44 surrounds the first portion 24 of the outer surface 22 of the respective marker 12. The outwardly facing surface 52 of a respective first annular magnet 44 is aligned with the second portion 26 of the outer wall 34 of the respective marker 12.

A plurality of second annular magnets 56 is provided and each second annular magnet 56 of the plurality of second annular magnets 56 is coupled to a respective one of the plurality of caps 30. The second annular magnet 56 on the respective cap 30 magnetically engages a respective first annular magnet 44 on a respective marker 12 when the respective cap 30 is removably mated to the respective marker 12 for retaining the respective cap 30 on the respective marker 12. Each second annular magnet 56 of the plurality of second annular magnets 56 has a top surface 58 and a bottom surface 60. The top surface 58 of each second annular magnet 56 of the plurality of second annular magnets 56 is coupled to lower edge 36 of the outer wall 34 of a respective one of the plurality of caps 30. Additionally, the bottom surface 60 of a respective second annular magnet 56 on a respective cap 30 magnetically engages the upper surface 48 of a respective first annular magnet 44 on a respective marker 12 when the respective cap 30 is releasably mated to the respective marker 12.

A plurality of third annular magnets 62 is provided and each third annular magnet 62 of the plurality of third annular magnets 62 is coupled to a respective one of the plurality of caps 30. Each third annular magnet 62 of the plurality of third annular magnets 62 is positioned on an opposite end of the respective cap 30 from the second annular magnet 56 on the respective cap 30. Each third annular magnet 62 of the plurality of third annular magnets 62 has a bottom surface 64 of the third annular magnets 62 and a top surface 66 of the third annular magnets 62. Additionally, each third annular magnet 62 of the plurality of third annular magnets 62 has an inside surface 68 extending between the top surface 66 of a respective third annular magnet 62 and the bottom surface 60 of the respective third annular magnet 62.

The outer wall 34 of a respective cap 30 has a second threshold 70 extending between the primary portion 40 of the outer wall 34 of the respective cap 30 and the secondary portion 42 of the outer wall 34 of the respective cap 30. The bottom surface 64 of a respective third annular magnet 62 is coupled to the second threshold 70 of a respective cap 30. Furthermore, the inside surface 68 of a respective third annular magnet 62 surrounds the secondary portion 42 of the outer wall 34 of a respective cap 30. The top surface 66 of a respective third annular magnet 62 is aligned with the top wall 32 of a respective cap 30.

A plurality of fourth annular magnets 72 is provided and each fourth annular magnet 72 of the plurality of fourth annular magnets 72 is coupled to a respective one of the plurality of markers 12. Each fourth annular magnet 72 of the plurality of fourth annular magnets 72 is positioned on an opposite end of a respective marker 12 from the first annular magnet 44 on the respective marker 12. The second portion 26 of the outer wall 34 of each marker 12 of the plurality of markers 12 has a recess 74. Additionally, the recess 74 associated with a respective marker 12 extends from the bottom end 20 of the respective marker 12 toward the medial portion 28 of the outer wall 34 of the respective marker 12. Each marker 12 of the plurality of markers 12 has a third threshold 76 extending between the recess 74 and the second portion 26 of the outer wall 34 of a respective marker 12. In addition, each marker 12 of the plurality of markers 12 has a well 78 extending into the bottom end 20.

Each fourth annular magnet 72 of the plurality of fourth annular magnets 72 has an uppermost surface 80 and a lowermost surface 82. Additionally, each fourth annular magnet 72 of the plurality of fourth annular magnets 72 has an interior surface 84 extending between the uppermost surface 80 and the lowermost surface 82. The uppermost surface 80 of each fourth annular magnet 72 of the plurality of fourth annular magnets 72 is coupled to the third threshold 76. The interior surface 84 of each fourth annular magnet 72 of the plurality of fourth annular magnets 72 surrounds the recess 74 in the second portion 26 of the outer wall 34 of a respective marker 12. In addition, the lowermost surface 82 of each fourth annular magnet 72 of the plurality of fourth annular magnets 72 is aligned with the bottom end 20 of a respective marker 12. The top surface 66 of a respective third annular magnet 62 associated with a respective cap 30 magnetically engages the lowermost surface 82 of a respective fourth annular magnet 72 when the respective cap 30 is positioned on the bottom end 20 of a respective marker 12 for retaining the respective cap 30 on the bottom end 20 of the respective marker 12.

A panel 86 is provided and the panel 86 is comprised of a ferromagnetic material. Each fourth annular magnet 72 of the plurality of fourth annular magnets 72 magnetically engages the panel 86 when the plurality of markers 12 is positioned on the panel 86 for storing the plurality of markers 12. The panel 86 has a topmost surface 88 and the lowermost surface 82 of a respective fourth annular magnet 72 on a respective marker 12 magnetically engages the topmost surface 88 of the panel 86 when the respective marker 12 is positioned on the panel 86 for storage. The lowermost surface 82 of a respective fourth annular 72 on a respective marker 12 can magnetically engage a door of a refrigerator, for example, or other type of ferromagnetic surface for storing the markers 12.

In use, a respective cap 30 is removed from a respective marker 12 and the respective cap 30 is positioned on the bottom end 20 of the respective marker 12 such that the second annular magnet 56 on the respective cap 30 magnetically engages the fourth annular magnet 72 on the respective marker 12. The respective cap 30 is magnetically retained on the bottom end 20 of the respective marker 12 to inhibit the respective cap 30 from becoming lost. Furthermore, children or other users that might have limited fine motor skills can easily attach the respective cap 30 to the bottom end 20 of the respective marker 12 to store the respective cap 30. The respective cap 30 is replaced on the top end 18 of the respective marker 12 and the second annular magnet 56 on the respective cap 30 magnetically engages the first annular magnet 44 on the respective marker 12 to retain the respective cap 30 on the top end 18 of the respective marker 12 to inhibit the tip 16 of the respective marker 12 from drying.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A magnetic marker device comprising:
a plurality of markers, each marker of said plurality of markers storing a fluid ink, each marker of said plurality of markers including a tip, said tip associated with a respective marker of said plurality of markers being in fluid communication with said fluid ink stored in said respective marker, said tip associated with each marker of said plurality of markers being comprised of a fluid permeable material, said tip associated with a respective marker of said plurality of markers absorbing said fluid ink stored in said respective marker wherein said tip associated with said respective marker is configured to release said fluid ink stored in said respective marker onto a writing surface;
a plurality of caps, each cap of said plurality of caps being removably matable to a respective marker of said plurality of markers, a respective cap of said plurality of caps covering said tip associated with a respective marker when said respective cap is removably mated to said respective marker wherein said respective cap is configured to inhibit said tip associated with said respective marker from drying;
a plurality of first annular magnets, each first annular magnet of said plurality of first annular magnets being coupled to a respective one of said plurality of markers;
a plurality of second annular magnets, each second annular magnet of said plurality of second annular magnets being coupled to a respective one of said plurality of caps, said second annular magnet on said respective cap magnetically engaging a respective first annular magnet on a respective marker when said respective cap is removably mated to said respective marker for retaining said respective cap on said respective marker;
a plurality of third annular magnets, each third annular magnet of said plurality of third annular magnets being coupled to a respective one of said plurality of caps, each third annular magnet of said plurality of third annular magnets being positioned on an opposite end of said respective cap from said second annular magnet on said respective cap;
a plurality of fourth annular magnets, each fourth annular magnet of said plurality of fourth annular magnets being coupled to a respective one of said plurality of markers, each fourth annular magnet of said plurality of fourth annular magnets being positioned on an opposite end of a respective marker from said first annular magnet on said respective marker, a respective third annular magnet on a respective cap magnetically engages a respective fourth annular magnet on a respective marker to store said cap when said respective marker is employed for writing.

2. The magnetic marker device according to claim 1, further comprising:
each marker of said plurality of markers having a top end and a bottom end and an outer surface extending between said top end and said bottom end;
said outer surface of each marker of said plurality of markers having a first portion and a second portion and a medial portion extending between first portion and said second portion;
said medial portion of said outer surface of a respective marker of said plurality of markers having a diameter being less than a diameter of said second portion of said outer surface of said respective marker;
said first portion of said outer surface of said respective marker having a diameter being less than said diameter of said medial portion of said outer surface of said respective marker;
said first portion of said outer surface of said respective marker being associated with said top end of said respective marker;
said second portion of said outer surface of said respective marker being associated with said bottom end of said respective marker; and
said medial portion of said outer surface of said respective marker being positioned closer to said top end of said respective marker than said bottom end of said respective marker.

3. The magnetic marker device according to claim 1, further comprising:
each cap of said plurality of caps having a top wall and an outer wall extending downwardly from said top wall;
said outer wall of a respective cap of said plurality of caps being continuously arcuate about a center of said top wall of said respective cap such that said respective cap has a cylindrical shape;
said outer wall of each cap of said plurality of caps having a lower edge;
said lower edge of said outer wall of said respective cap defining an opening into said respective cap;
said opening in said respective cap insertably receiving said tip associated with a respective marker when said respective cap is releasably mated to said respective marker.

4. The magnetic marker device according to claim 3, further comprising:
said outer wall of each cap of said plurality of caps having a primary portion and a secondary portion;
said secondary portion of said outer wall of a respective cap having a diameter being less than said primary portion of said outer wall of said respective cap;
said primary portion of said outer wall of said respective cap being associated with said lower edge of said outer wall of said respective cap; and
said secondary portion of said outer wall of said respective cap being associated with said top wall of said respective cap.

5. The magnetic marker device according to claim 2, further comprising:
each first annular magnet of said plurality of first annular magnets having a lower surface and an upper surface;
each first annular magnet of said plurality of first annular magnets having an inwardly facing surface extending between said upper surface and said lower surface;
each first annular magnet of said plurality of first annular magnets having an outwardly facing surface extending between said upper surface and said lower surface;
said outer surface of a respective marker of said plurality of markers having a first threshold extending between said medial portion of said outer surface of said respective marker and said second portion of said outer surface of said respective marker;
said lower surface of each first annular magnet of said plurality of first annular magnets being coupled to said first threshold of a respective marker;
said inwardly facing surface of a respective first annular magnet of said plurality of first annular magnets surrounding said first portion of said outer surface of said respective marker; and
said outwardly facing surface of a respective first annular magnet being aligned with said second portion of said outer wall of said respective marker.

6. The magnetic marker device according to claim 3, further comprising:
each second annular magnet of said plurality of second annular magnets having a top surface and a bottom surface; and
said top surface of each second annular magnet of said plurality of second annular magnets being coupled to lower edge of said outer wall of a respective one of said plurality of caps.

7. The magnetic marker device according to claim 6, further comprising:
each first annular magnet of said plurality of first annular magnets has an upper surface; and
said bottom surface of a respective second annular magnet on a respective cap magnetically engaging said upper surface of a respective first annular magnet on a respective marker when said respective cap is releasably mated to said respective marker.

8. The magnetic marker device according to claim 4, further comprising:
each third annular magnet of said plurality of third annular magnets having a bottom surface of said third annular magnets and a top surface of said third annular magnets;
each third annular magnet of said plurality of third annular magnets having an inside surface extending between said top surface of a respective third annular magnet and said bottom surface of said respective third annular magnet;
each marker of said plurality of markers having a first threshold;
said outer wall of a respective cap having a second threshold extending between said primary portion of said outer wall of said respective cap and said secondary portion of said outer wall of said respective cap;
said bottom surface of a respective third annular magnet being coupled to said second threshold of a respective cap;
said inside surface of a respective third annular magnet surrounding said secondary portion of said outer wall of a respective cap; and
said top surface of a respective third annular magnet being aligned with said top wall of a respective cap.

9. The magnetic marker device according to claim 2, further comprising:
said second portion of said outer wall of each marker of said plurality of markers having a recess;
said recess associated with a respective marker extending from said bottom end of said respective marker toward said medial portion of said outer wall of said respective marker;
each marker of said plurality of markers having a first threshold;
each cap of said plurality of caps having a second threshold;
each marker of said plurality of markers having a third threshold extending between said recess and said second portion of said outer wall of a respective marker; and
each marker of said plurality of markers having a well extending into said bottom end.

10. The magnetic marker device according to claim 9, further comprising:
each fourth annular magnet of said plurality of fourth annular magnets having an uppermost surface and a lowermost surface;
each fourth annular magnet of said plurality of fourth annular magnets having an interior surface extending between said uppermost surface and said lowermost surface;
said uppermost surface of each fourth annular magnet of said plurality of fourth annular magnets being coupled to said third threshold;
said interior surface of each fourth annular magnet of said plurality of fourth annular magnets surrounding said recess in said second portion of said outer wall of a respective marker; and
said lowermost surface of each fourth annular magnet of said plurality of fourth annular magnets being aligned with said bottom end of a respective marker.

11. The magnetic marker device according to claim 1, wherein:
each marker of said plurality of markers has a bottom end;
each third annular magnet of said plurality of third annular magnets has a top surface;
each fourth magnet of said plurality of fourth magnets has a lowermost surface; and
said top surface of a respective third annular magnet associated with a respective cap magnetically engaging said lowermost surface of a respective fourth annular magnet when said respective cap is positioned on said bottom end of a respective marker for retaining said respective cap on said bottom end of said respective marker.

12. The magnetic marker device according to claim 1, further comprising:
a panel being comprised of a ferromagnetic material; and
each fourth annular magnet of said plurality of fourth annular magnets magnetically engaging said panel when said plurality of markers is positioned on said panel for storing said plurality of markers.

13. The magnetic marker device according to claim 12, further comprising:
said panel having a topmost surface;
each fourth annular magnet of said plurality of fourth annular magnets has a lowermost surface; and
said lowermost surface of a respective fourth annular magnet on a respective marker magnetically engaging said topmost surface of said panel when said respective marker is positioned on said panel for storage.

14. A magnetic marker device comprising:
a plurality of markers, each marker of said plurality of markers storing a fluid ink, each marker of said plurality of markers including a tip, said tip associated with a respective marker of said plurality of markers being in fluid communication with said fluid ink stored in said respective marker, said tip associated with each marker of said plurality of markers being comprised of a fluid permeable material, said tip associated with a respective marker of said plurality of markers absorbing said fluid ink stored in said respective marker wherein said tip associated with said respective marker is configured to release said fluid ink stored in said respective marker onto a writing surface, each marker of said plurality of markers having a top end and a bottom end and an outer surface extending between said top end and said bottom end, said outer surface of each marker of said plurality of markers having a first portion and a second portion and a medial portion extending between first portion and said second portion, said medial portion of said outer surface of a respective marker of said plurality of markers having a diameter being less than a diameter of said second portion of said outer surface of said respective marker, said first portion of said outer surface of said respective marker having a diameter being less than said diameter of said medial portion of said outer surface of said respective marker, said first portion of said outer surface of said respective marker being associated with said top end of said respective marker, said second portion of said outer surface of said respective marker being associated with said bottom end of said respective marker, said medial portion of said outer surface of said respective marker being positioned closer to said top end of said respective marker than said bottom end of said respective marker;
a plurality of caps, each cap of said plurality of caps being removably matable to a respective marker of said plurality of markers, a respective cap of said plurality of caps covering said tip associated with a respective marker when said respective cap is removably mated to said respective marker wherein said respective cap is configured to inhibit said tip associated with said respective marker from drying, each cap of said plurality of caps having a top wall and an outer wall extending downwardly from said top wall, said outer wall of a respective cap of said plurality of caps being continuously arcuate about a center of said top wall of said respective cap such that said respective cap has a cylindrical shape, said outer wall of each cap of said plurality of caps having a lower edge, said lower edge of said outer wall of said respective cap defining an opening into said respective cap, said opening in said respective cap insertably receiving said tip associated with a respective marker when said respective cap is releasably mated to said respective marker, said outer wall of each cap of said plurality of caps having a primary portion and a secondary portion, said secondary portion of said outer wall of a respective cap having a diameter being less than said primary portion of said outer wall of said respective cap, said primary portion of said outer wall of said respective cap being associated with said lower edge of said outer wall of said respective cap, said secondary portion of said outer wall of said respective cap being associated with said top wall of said respective cap;
a plurality of first annular magnets, each first annular magnet of said plurality of first annular magnets being coupled to a respective one of said plurality of markers, each first annular magnet of said plurality of first annular magnets having a lower surface and an upper surface, each first annular magnet of said plurality of first annular magnets having an inwardly facing surface extending between said upper surface and said lower surface, each first annular magnet of said plurality of first annular magnets having an outwardly facing surface extending between said upper surface and said lower surface, said outer surface of a respective marker of said plurality of markers having a first threshold extending between said medial portion of said outer surface of said respective marker and said second portion of said outer surface of said respective marker, said lower surface of each first annular magnet of said plurality of first annular magnets being coupled to said first threshold of a respective marker, said inwardly facing surface of a respective first annular magnet of said plurality of first annular magnets surrounding said first portion of said outer surface of said respective marker, said outwardly facing surface of a respective first annular magnet being aligned with said second portion of said outer wall of said respective marker;
a plurality of second annular magnets, each second annular magnet of said plurality of second annular magnets being coupled to a respective one of said plurality of caps, said second annular magnet on said respective cap magnetically engaging a respective first annular magnet on a respective marker when said respective cap is removably mated to said respective marker for retaining said respective cap on said respective marker, each second annular magnet of said plurality of second annular magnets having a top surface and a bottom surface, said top surface of each second annular magnet of said plurality of second annular magnets being coupled to lower edge of said outer wall of a respective one of said plurality of caps, said bottom surface of a respective second annular magnet on a respective cap magnetically engaging said upper surface of a respective first annular magnet on a respective marker when said respective cap is releasably mated to said respective marker;
a plurality of third annular magnets, each third annular magnet of said plurality of third annular magnets being coupled to a respective one of said plurality of caps, each third annular magnet of said plurality of third annular magnets being positioned on an opposite end of said respective cap from said second annular magnet on said respective cap, each third annular magnet of said plurality of third annular magnets having a bottom surface of said third annular magnets and a top surface of said third annular magnets, each third annular magnet of said plurality of third annular magnets having an inside surface extending between said top surface of a respective third annular magnet and said bottom surface of said respective third annular magnet, said outer wall of a respective cap having a second threshold extending between said primary portion of said outer wall of said respective cap and said secondary portion of said outer wall of said respective cap, said bottom surface of a respective third annular magnet being coupled to said second threshold of a respective cap, said inside surface of a respective third annular magnet surrounding said secondary portion of said outer wall of a respective cap, said top surface of a respective third annular magnet being aligned with said top wall of a respective cap;
a plurality of fourth annular magnets, each fourth annular magnet of said plurality of fourth annular magnets being coupled to a respective one of said plurality of markers, each fourth annular magnet of said plurality of fourth annular magnets being positioned on an opposite end of a respective marker from said first annular magnet on said respective marker, a respective third annular magnet on a respective cap magnetically engages a respective fourth annular magnet on a respective marker to store said cap when said respective marker is employed for writing, said second portion of said outer wall of each marker of said plurality of markers having a recess, said recess associated with a respective marker extending from said bottom end of said respective marker toward said medial portion of said outer wall of said respective marker, each marker of said plurality of markers having a third threshold extending between said recess and said second portion of said outer wall of a respective marker, each marker of said plurality of markers having a well extending into said bottom end, each fourth annular magnet of said plurality of fourth annular magnets having an uppermost surface and a lowermost surface, each fourth annular magnet of said plurality of fourth annular magnets having an interior surface extending between said uppermost surface and said lowermost surface, said uppermost surface of each fourth annular magnet of said plurality of fourth annular magnets being coupled to said third threshold, said interior surface of each fourth annular magnet of said plurality of fourth annular magnets surrounding said recess in said second portion of said outer wall of a respective marker, said lowermost surface of each fourth annular magnet of said plurality of fourth annular magnets being aligned with said bottom end of a respective marker, said top surface of a respective third annular magnet associated with a respective cap magnetically engaging said lowermost surface of a respective fourth annular magnet when said respective cap is positioned on said bottom end of a respective marker for retaining said respective cap on said bottom end of said respective marker; and
a panel being comprised of a ferromagnetic material, each fourth annular magnet of said plurality of fourth annular magnets magnetically engaging said panel when said plurality of markers is positioned on said panel for storing said plurality of markers, said panel having a topmost surface, said lowermost surface of a respective fourth annular magnet on a respective marker magnetically engaging said topmost surface of said panel when said respective marker is positioned on said panel for storage.
